(19) United States
(12) Patent Application Publication
(10) Pub. No.: US 2014/0258511 A1
(43) Pub. Date: Sep. 11, 2014

(54) Methods and Apparatus for Reestablishing Secure Network Communications

(71) Applicants: Caleb Sima, San Francisco, CA (US); Jeffrey Forristal, San Francisco, CA (US)

(72) Inventors: Caleb Sima, San Francisco, CA (US); Jeffrey Forristal, San Francisco, CA (US)

(73) Assignee: Bluebox Security Inc., San Francisco, CA (US)

(21) Appl. No.: 14/203,738

(22) Filed: Mar. 11, 2014

Related U.S. Application Data
(60) Provisional application No. 61/776,703, filed on Mar. 11, 2013.

(51) Int. Cl. H04L 29/06; H04L 12/26

(52) U.S. Cl. CPC H04L 63/00; H04L 43/0876
USPC 709/224

(57) ABSTRACT

A computer-implemented, method for monitoring and establishing a secure communication session to a client computing system by a secure communication server system programmed to perform the method including monitoring in the secure communication server system, a network traffic level between the client computing system and the secure communication server system, determining in the secure communication server system, whether the network traffic level drops below a set network traffic level, and wherein when the network traffic level is determined by the secure communication server system to drop below the set network traffic level, the method includes sending with the secure communication server system, a management communication to the client computing system to reestablish a secure communication session with the secure communication server system. A subsequent secure communication session between the client computing system and the secure communication server system may or may not be established.

### CROSS-REFERENCES TO RELATED APPLICATIONS

The present application is a continuation of (provisional) Application No. 61/776,703; filed on Mar. 11, 2013, the full disclosures of which is incorporated herein by reference.

### FIELD OF THE INVENTION

The present invention relates to secure network communications, such as found in virtual private networks. More specifically, embodiments of the present invention relate to methods and apparatus for automatically reestablishing secure network communications by client devices, utilizing a secure communications server to monitor the client devices' secure network communications.

### BACKGROUND OF THE INVENTION

Secure communications between portable devices and networks is becoming the only acceptable means of the use of communications devices for corporate, governmental and other organizations as well as individuals requiring secure communications. Such systems are readily available and typically require the user of a device to communicate with a server to log into the secure network. However, portable devices, in order to save power in their batteries, tend to time out and go into hibernated or sleep modes. Such power-saving modes tend to cause the dropping of the secure connection and typically in a manner that may not be detected by the user. A subsequent communication, therefore, might proceed on a non-secure connection channel, in violation of established protocols and/or to the danger of the communication.

Cellular telephones commonly disconnect from networks when, for example they go to sleep, that is they go into a low activity sleep mode, in which the screen is darkened in an effort to save power. Such telephones usually only reconnect to the network when they are again activated, such as when the user pushes a button or begins to use a telephone function; or, as programmed they wake out of sleep mode once every 15-60 minutes, for example, to check for messages and emails. Additionally, it is possible for the telephone to run out of battery/charge, get switched into airplane mode, be contained behind a captive network portal or are taken out of the zone for signal and/or are otherwise prevented from reconnecting. In some cases, a user may actually be preventing the device from reconnecting, because the user wants to “hide” his activity.

Historically, in the art, the decision to make a secure connection is left up to the device/user or a combination thereof There are myriad reasons on why the device and/or user may decide to not make a secure connection. However, that secure connection may be necessary for reasons like secure management & monitoring by an employer, for national security reasons, reasons of privilege and others. It would therefore be desirable to have a method to interrogate a device to make the secure connection, when it may not have normally done so otherwise. Such a method would also permit the organization, business or governmental or other, make the decision that the secure network connection must be established and establish the communication such that a user cannot decide on its own to bypass the secure network, for whatever reason.

Other objects and advantages of the present invention will become apparent as the description proceeds.

### SUMMARY OF THE INVENTION

In accordance with the present invention, a computer-implemented method for monitoring and establishing a secure communication session by a client to a computing system is provided. The system acts via a secure communication server system programmed to perform the method, which comprises the steps of monitoring, in the secure communication server system, a network traffic level between the computing system and the secure communication server system; determining whether the network traffic level drops below a set network traffic level; sending, a communication to the computing system to reestablish a secure communication session when the network traffic level is determined to drop below the set network traffic level; and establishing, a secure communication session between the computing system and the secure communication server system.

In the inventive method the network traffic level setting is determined from a group consisting of one or more of the following parameters: a chosen number of DNS queries, a chosen number of web requests, a chosen number of network packets, and a chosen number of VPN keep-alive transactions. In embodiments, the secure communication server system compromises a Mobile Device Management (MDM) server and the communication to the computing system, to reestablish a secure communication session, comprises a Mobile Device Management (MDM) communication.

In other embodiments, the secure communication server system can comprise a VPN server and the secure communication session comprises a VPN session. In such embodiments the network traffic level between the client computing system and the secure communication server system can comprise the steps of: establishing in the communication server system the VPN session between the client computing system and the VPN server; monitoring a network traffic level of the computing system for a period of time and determining the network traffic level in response to the network traffic level of the computing system for that period of time. In such embodiments, the network traffic level setting can be determined from a group consisting of one or more of the following parameters: a chosen number of DNS queries, a chosen number of web requests, a chosen number of network packets, and a chosen number of VPN keep-alive transactions.

It will be understood that the computing systems of the present invention can be any of the following: Apple iOS device, an Android device, a Windows phone device, a Windows tablet device, a Tizen device, a Firefox OS device, an Amazon Kindle device, and a Blackberry device. For example, in one embodiment the computing system comprises an Apple iPhone.

Additionally, it will be understood that in the method of the present invention, initiating a secure communication session between the computing system and the secure communication server system, can include the additional steps of: refreshing the secure communication session configuration data of the client computer system; sending secure communication network traffic to the secure communication server system; and receiving secure communication network traffic from the secure communication server system.

In one particular embodiment of the present invention a computer-implemented method for monitoring and establishing a secure communication session to a client computing system by a secure communication server system, programmed to perform the method, comprises the step of providing an indicator signal to indicate when in a timing process determines a particular amount of time has elapsed. When such an indicator signal is provided by the timing process, the present invention can include the additional step of transmitting a communication to the client computing system if no current secure communication session exists between the client computing system and the secure communication server system. By doing this, establishing, with the secure communication server system, a secure communication session between the computing system and the secure communication server system.

It will be seen, in embodiments with these additional steps, that the particular amount of time selected is often shown as within a range of about 1 minute to about 15 minutes, however a range of hours can also be a preferred range of time. The examples shown, then should not be seen as limiting but only exemplary. Further, it will be understood that in such methods of the invention the secure communication server system can comprise a VPN server. However, in embodiments of the invention the secure communication server system can compromise a Mobile Device Management (MDM) server and in such cases, the management communication comprises a Mobile Device Management (MDM) communication.

Additionally, when establishing the secure communication session between the client computing system and the secure communication server system, can include the additional steps of refreshing the secure communication session configuration data of the client computing system, sending secure communication network traffic to the secure communication server system, and receiving the secure communication network traffic from the secure communication server system.

A more detailed explanation of the invention is provided in the following description and claims and is illustrated in the accompanying drawings.

### BRIEF DESCRIPTION OF THE DRAWINGS

FIG. 1 is a representation of a system using the method of the present invention;

FIG. 2A is a flow chart of the functionality of the present invention;

FIG. 2B is a further flow chart of the functionality of the present invention; and

FIG. 3 is a further flow chart of the functionality of the present invention.

### DETAILED DESCRIPTION OF THE ILLUSTRATIVE EMBODIMENT

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of an Illustrative Embodiment”) relates to a requirement of the United States Patent Office, and should not be found to limit the subject matter disclosed herein.

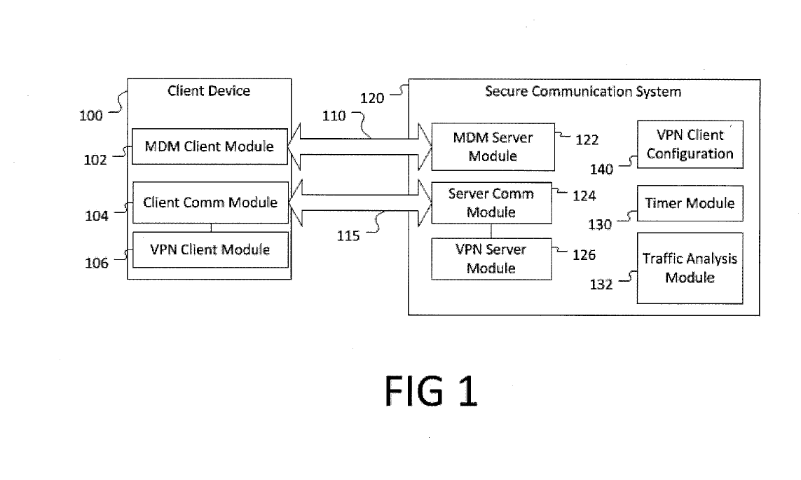

Referring to FIG. 1, client device 100 embodies a management client module 102, a client communications module 104, and a VPN client module 106. The management client module 102 embodies a client module capable of taking device management configuration queries and updates from a remote server, referred to as Mobile Device Management or “MDM” in the industry. The management client module 102 can communicate via the Apple MDM protocol, Google GCM, Apple APNS, Windows Phone Device Management Protocol, or the like, as known by persons having skill in the art. Persons having ordinary skill in the art will recognize multiple ways that management client module 102 can be created to achieve similar functionality to that explained herein, without departing from the novel scope of the present invention. The client communications module 104 can communicate on a communications network, such as Ethernet, Wifi, Bluetooth, CDMA, GSM, LTE, HPSA, cellular, or the like. The composition of client device 100 is typical of a mobile device found in the industry, such as an Android mobile phone, Apple mobile phone, Android mobile tablet, Apple mobile tablet, Apple MacOS X laptop, Windows Phone, Blackberry phone, Windows tablet, Windows laptop, or the like.

The secure communication system 120 embodies a management server module 122, a server communications module 124, a VPN server module 126, and a memory containing one or more VPN client configurations 140. The secure communication system 120 will contain one or more from the list of a timer module 130 and a traffic analysis module 132. The management server module 122 embodies a server module capable of sending device management configuration queries and updates to a mobile client, referred to as Mobile Device Management or “MDM” in the industry. The management server module 122 can communicate via the Apple MDM protocol, Google GCM, Apple APNS, Windows Phone Device Management Protocol, or the like. Someone skilled in the art will recognize different ways the management server module 122 can be created to achieve the same functionality.

The client device 100 is configured to utilize the secure communication system 120 for security services. Specifically, the management client module 102 is configured to communicate to the management server module 122 via network communications 110. The client device 100 is also configured to utilize the VPN client module 106 to communicate via client communication module 104 on a communications network 115 to the VPN server module 126 via server communications module 124. The VPN client module 106 and VPN server module 126 can embody one or more secure communication technologies known as Virtual Private Networks in the industry. For example, the VPN client module 106 and VPN server module 126 can embody IPSec, PPTP, L2TP, MPLS, SSL, TLS, or the like. Persons having ordinary skill in the art will recognize different ways two network modules can be implemented to create a secure VPN, without departing from the novel scope of the present invention.

In one embodiment, at certain configured time intervals, the timer module 130 will send a logic signal to the management server module 122. That causes the management server module 122 to send the VPN client configuration 140 to the management client module 102 of the client device 100. Upon reception of VPN client configuration 140 by the client management module 102, the client device 100 updates the configuration of the VPN client module 106. This update operation will cause VPN client module 106 to re-establish a connection to the VPN server module 126 over communications network 115. In this manner, the timer module acts to periodically cause a VPN client configuration refresh, which in turns causes the device to re-establish a connection to the secure communication system.

In another embodiment, the traffic analysis module 132 monitors the network communications 115 via server communications module 124. The traffic analysis module 132 embodies logic to detect one or more conditions relating to network communications 115, including a decrease in the amount of network communications, an absence of network communications, inclusion of specific data in the network communications, or the like. Persons having ordinary skill in the art will recognize different ways traffic analysis can be performed to detect the occurrence of a network monitoring condition, without departing from the novel scope of the present invention. Upon confirming a network monitoring condition, the traffic analysis module 132 will send a logic signal to the management server module 122. That causes the management server module 122 to send the VPN client configuration 140 to the management client module 102 of the client device 100. Upon reception of VPN client configuration 140 by the client management module 102, the client device 100 updates the configuration of the VPN client module 106. This update operation will cause VPN client module 106 to re-establish a connection to the VPN server module 126 over communications network 115. In this manner, the traffic analysis module acts to a VPN client configuration refresh, which in turns causes the device to re-establish a connection to the secure communication system, whenever certain network communication conditions are witnessed.

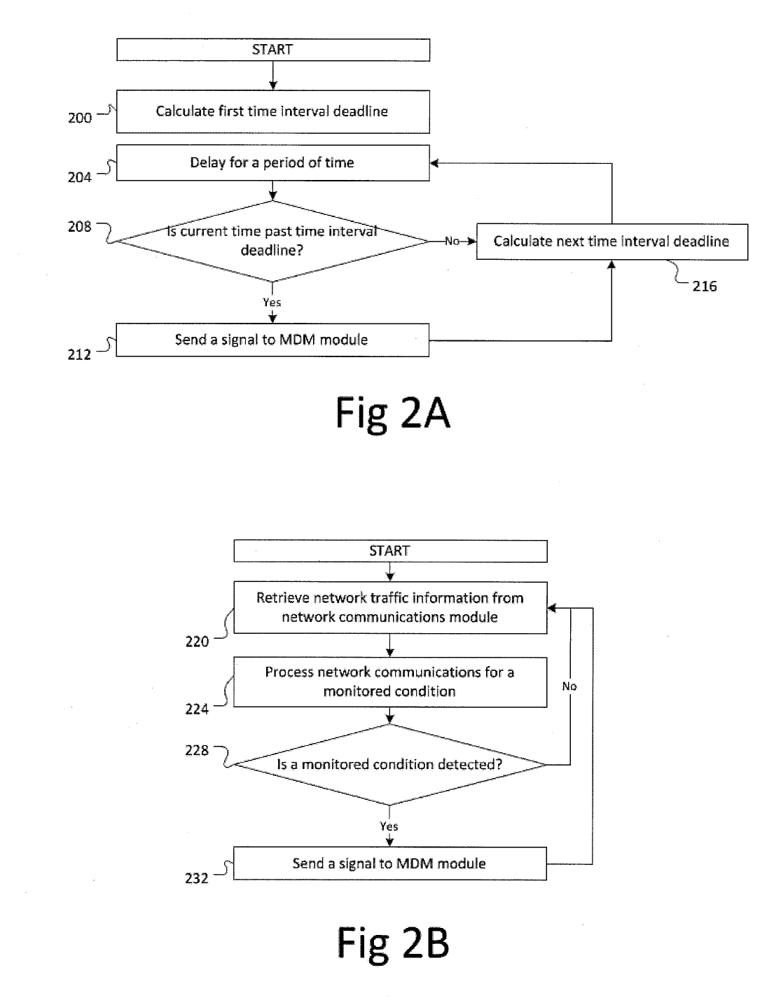

Referring to FIG. 2A, the diagram illustrates the embodiment of the timer module 130 (FIG. 1) in the secure communication system 120 (FIG. 1). The timer module 130 (FIG. 1) calculates 200 a first time interval deadline, and then delays 204 for a pre-determined period of time. Next, the current time is checked to see if it has passed the previously calculated deadline 208. If the current time has passed the previously calculated deadline 208, then a signal is sent 212 to the MDM module 122 (FIG. 1), a next time interval deadline is calculated 216 and the process repeats. If the current time has not passed the previously calculated deadline 208, a next time interval deadline is calculated 216 immediately, and the process repeats.

Referring now to FIG. 2B, a schematic embodiment of the traffic analysis module 132 (FIG. 1) in the secure communication system 120 (FIG. 1) is shown. The traffic analysis module 132 (FIG. 1) retrieves 220 network traffic information from the server communications module 124 (FIG. 1). The network traffic information can include, for example, one or more of statistics on traffic received, statistics on traffic sent, time information regarding the last time traffic was received, time information regarding the last time traffic was sent, the traffic data, an indicator that indicates no traffic was received, an indicator that indicates no traffic was sent, or the like. Persons having ordinary skill in the art will recognize different types of information that are applicable to include as network traffic information, without departing from the novel scope of the present invention. Once the traffic analysis module 132 (FIG. 1) retrieves 220 the network traffic information, it processes 224 the network traffic information to look 228 for monitored conditions. Monitored conditions can include one or more of a decrease in the amount of network communications, an absence of network communications, and inclusion of specific data in the network communications, or the like. Persons having ordinary skill in the art will recognize different ways traffic analysis can be performed to detect the occurrence of a network monitoring condition, without departing from the novel scope of the present invention.

Referring again to FIG. 2B, the processing result is inspected 228 to determine if a monitored condition was detected. If a monitored condition was detected, a signal is sent 232 to the MDM module 122 (FIG. 1) and the process of determining if a monitored condition exists, repeats itself by starting to retrieve 220 more network traffic information. In the alternative, if a monitored condition was not detected, the process immediately repeats itself by retrieving 220 more traffic information.

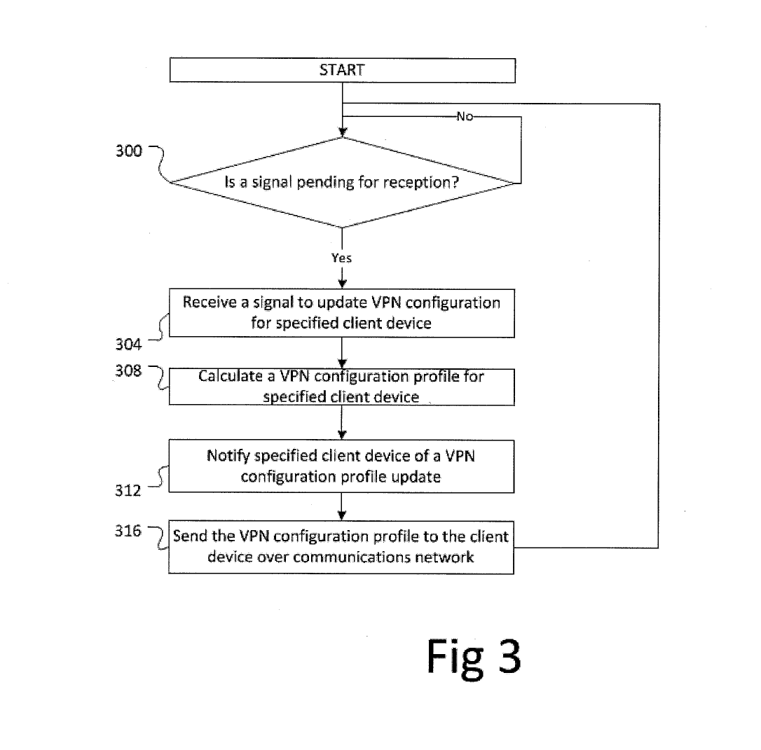

Now, referring to FIG. 3, a schematic illustration of an embodiment of the management server module 122 (FIG. 1) in the secure communication system 120 (FIG. 1) s shown. The management server module 122 checks 300 if there is a signal pending for reception. If there is no signal pending, then the process repeats as shown. If there is a signal pending, the management server module 122 receives 304 a signal that a specified client device 100 needs a VPN configuration update. A VPN configuration profile is calculated 308 for the specified client device 100; notification 312 of an updated VPN configuration profile is given to the specified client device. The VPN configuration profile is then sent 316 to the specified client device over a communications network 110 (FIG. 1), and the process repeats 300 itself by waiting for reception of the next signal.

It will be seen that when the server-side of the present invention recognizes that the phone has been away for too long, it sends it a queued message to come back and check in, just to make sure the phone is in a proper operational state. The nature of the message queuing is such that the message will be held by a network intermediary until the device is up and running to receive the message. This means the device should get it at the first available opportunity it is awake and connected to a working (non-secure) network.

In one embodiment of the invention to the system tells the device to come back and check in by (re)push an MDM VPN profile down to the device. This is because, normally, there is no way for a server to cause the device to reconnect a secure connection. The present invention relies on the novel use of the MDM VPN profile capabilities included with devices by default. MDM (Mobile Device Management) is, as is known to persons having ordinary skill in the art, a centralized way to manage a fleet of mobile devices, by for example an IT department, or the like. By using MDM to repush the VPN profile to the device, the device is caused to refresh the VPN configuration, which in turn triggers the use of the VPN to turn on the secure connection. Such action also overwrites any changes the user may have done to try to disable the VPN configuration and thus disable the secure connection.

Once that secure connection is established, it can be utilized for any purposes, including traffic monitoring, logging, auditing, inhibiting access to certain destinations, scanning for threats, increased privacy on untrusted networks, and others.

In various embodiments, a secure communications server may include server security software running directly upon a computer server; on a virtual machine implemented on a computer server; or the like. Additionally, client devices may include client security software running upon mobile devices (e.g. Apple iOS device, Android-based device), smart phones (e.g. Apple iPhone, Samsung Galaxy S3), computers, and the like. Both types of computing devices typically include one or more processors; memory for storage of data, executable (client or server) security software, embodiments of the present invention, and the like; and communications mechanisms (e.g. wired, wireless) for intercommunication.

Embodiments of the present invention force a client device to automatically refresh a secure communications connection (e.g. VPN) with a remote server upon receiving a management communication from a secure communications server. In various embodiments, the management communication may be a Mobile Device Management (MDM) communication, any other communication that communicates with management software resident upon the client device, or the like.

The management communication from a secure communications server is sent in occurrence of one or more events. These events may include a drop-off, reduction, or absence in communications sent to and from the client device to the secure communications (remote) server; elapse of a period of time; or the like. In various embodiments, in response to the management communication, a client device (management software executed on the client device) refreshes or reloads a set of configuration data that specifies the establishment of a secure communications connection with a remote server. In some embodiments, the secure communications connection may be a virtual private network, e.g. VPN, or the like.

In various embodiments, if secure communication is reestablished between the secure communications server and the client device, the secure communications server may begin monitoring for the next event, as described above, and the process repeated.

In embodiments where secure communications is not established within an amount of time, the secure communications server may require a heightened level of user or administrator verification, before subsequent secure communications with the client device can reestablished; an indicator may be sent to an administrator or a log file of the lack of communication; a phone call, e-mail, text message, or the like may be automatically sent to user or administrator associated with the client device; and the like.

Further embodiments can be envisioned to one of ordinary skill in the art after reading this disclosure. As merely an example, embodiments above may include functionality where a client device also automatically monitors the events and automatically attempts to reestablish communications with the secure communications server. In other embodiments, combinations or sub-combinations of the above disclosed invention can be advantageously made.

Although an illustrative embodiment of the invention has been shown and described, it is to be understood that various modifications and substitutions may be made by those skilled in the art without departing from the novel spirit and scope of the invention.

What is claimed is:

1. A computer-implemented method for monitoring and establishing a secure communication session by a client to a computing system via a secure communication server system programmed to perform the method comprising the steps of:
Monitoring, in the secure communication server system, a network traffic level between the computing system and the secure communication server system;
determining in the secure communication server system, whether the network traffic level drops below a set network traffic level;
sending, with the secure communication server system, a communication to the computing system to reestablish a secure communication session with the secure communication server system when the network traffic level is determined by the secure communication server system to drop below the set network traffic level; and
establishing, with the secure communications system, a secure communication session between the computing system and the secure communication server system.

2. The method of claim 1, wherein the set network traffic level setting is determined from a group consisting of one or more of: a chosen number of DNS queries, a chosen number of web requests, a chosen number of network packets, and a chosen number of VPN keep-alive transactions.

3. The method of claim 1 wherein the secure communication server system compromises a Mobile Device Management (MDM) server.

4. The method of claim 1 wherein the communication to the computing system to reestablish a secure communication session with the secure communication server system comprises a Mobile Device Management (MDM) communication.

5. The method of claim 1 wherein the secure communication server system comprises a VPN server.

6. The method of claim 5, wherein the secure communication session comprises a VPN session; and
wherein the monitoring in the secure communication server system, the network traffic level between the client computing system and the secure communication server system comprise the steps of:
establishing in the communication server system the VPN session between the client computing system and the VPN server;
monitoring in the secure communication server system, a network traffic level of the computing system for a period of time; and
determining in the secure communication server system, the network traffic level in response to the network traffic level of the computing system for the period of time.

7. The method of claim 6, wherein the set network traffic level setting is determined from a group consisting of one or more of: a chosen number of DNS queries, a chosen number of web requests, a chosen number of network packets, and a chosen number of VPN keep-alive transactions.

8. The method of claim 1, wherein the computing system is selected from a group comprising: an Apple iOS device, an Android device, a Windows phone device, a Windows tablet device, a Tizen device, a Firefox OS device, an Amazon Kindle device, and a Blackberry device.

9. The method of claim 1 wherein the computing system comprises an Apple iPhone.

10. The method of claim 1, wherein initiating a secure communication session between the computing system and the secure communication server system, comprises the additional steps of:
refreshing the secure communication session configuration data of the client computer system;
sending secure communication network traffic to the secure communication server system; and
receiving in the computing system, secure communication network traffic from the secure communication server system.

11. The method of claim 10, wherein the secure communication session configuration data comprises a VPN client configuration profile.

12. A computer-implemented method for monitoring and establishing a secure communication session to a client computing system by a secure communication server system, programmed to perform the method, comprising the step of:
providing, with the secure communication server system, an indicator signal to indicate when a timing process determines that a particular amount of time has elapsed such that when the indicator signal is provided by the timing process, the method comprises the steps of:
transmitting, with the secure communication server system, a management communication to the client computing system, if no current secure communication session exists between the client computing system and the secure communication server system; and
establishing, with the client computing system, a secure communication session between the client computing system and the secure communication server system.

13. The method of claim 12, wherein the particular amount of time is selected from within a range of approximately 1 minute to several hours.

14. The method of claim 12, wherein the secure communication server system comprises a VPN server.

15. The method of claim 12, wherein the secure communication server system compromises a Mobile Device Management (MDM) server.

16. The method of claim 12, wherein the management communication comprises a Mobile Device Management (MDM) communication.

17. The method of claim 12, wherein the client computing system is selected from a group comprising: an Apple iOS device, an Android device, a Windows phone device, a Windows tablet device, a Tizen device, a Firefox OS device, an Amazon Kindle device, a Blackberry device.

18. The method of claim 12, wherein the client computing system comprises an Apple iPhone.

19. The method of claim 12, wherein establishing the secure communication session between the client computing system and the secure communication server system, comprises the additional steps of:
refreshing the secure communication session configuration data of the client computing system;
sending secure communication network traffic to the secure communication server system; and
receiving the secure communication network traffic from the secure communication server system.
